(19) United States
(12) Patent Application Publication
(10) Pub. No.: US 2015/0312066 A1
(43) Pub. Date: Oct. 29, 2015

(54) EQUALIZER CONTROL METHOD AND ASSOCIATED APPARATUS

(71) Applicant: JMicron Technology Corp., Hsin-Chu (TW)

(72) Inventors: Hua-Shih Liao, Hsinchu City (TW); Tang-Hui Yang, New Taipei City (TW); Wei-Chih Yeh, Hsinchu City (TW)

(21) Appl. No.: 14/517,930

(22) Filed: Oct. 20, 2014

(30) Foreign Application Priority Data
Apr. 24, 2014 (TW) 103114877

(51) Int. Cl. H04L 25/03; H04L 25/02

(52) U.S. Cl. CPC H04L 25/03885; H04L 25/0272

(57) ABSTRACT

An equalizer control method is provided, where the method may write a plurality of parameters into a programmable filter pattern register file of a receiver to set up the programmable filter pattern register file. The receiver includes a plurality of equalization settings for selection, and the method may further perform selection between the equalization settings of the receiver according to the parameters of the programmable filter pattern register file and a signal sequence received by the receiver. An associated equalizer control apparatus is also provided, where the equalizer control apparatus is disposed in a receiver. The receiver includes a plurality of equalization settings, and the equalizer control apparatus applies the equalizer control method to perform selection between the equalization settings of the receiver.

### BACKGROUND OF THE INVENTION

1. Field of the Invention

The disclosed embodiments of the present invention relate to an equalizer control method, and more particularly, to an equalizer control method, which utilizes a programmable filter pattern register file to control a high speed serial link (HSSL) equalizer, and an associated apparatus.

2. Description of the Prior Art

In the high speed serial link (HSSL) field, the core technology accurately sample high frequency serial data from a transmission cable. Typical standards include the Universal Serial Bus (USB) 3.0 and the Peripheral Component Interconnect express (PCIe) 3.0. An equalizer is commonly required to recover a serial data signal suffering from inter symbol interference (ISI).

Due to the similarity between standards, SerDes (Serializer/Deserializer) is a solution which can fulfill requirements of different standards. Some differences still exist, however, such as bandwidth, cable, coding scheme and transmission power, so that design specifications for the equalizer may be different depending on the particular standard used. A designer must therefore consider all the parameters relating to the different design specifications in order to enlarge the application to the greatest extent.

### SUMMARY OF THE INVENTION

One of the objectives of the present invention is to provide an equalizer control method, which utilizes a programmable filter pattern register file to control a high speed serial link (HSSL) equalizer, and an associated apparatus, to improve the issues in the prior art.

According to a first aspect of the invention, an equalizer control method is disclosed. The equalizer control method comprises: writing a plurality of parameters to a programmable filter pattern register file of a receiver to set up the programmable filter pattern register file, wherein the receiver possesses a plurality of equalization settings for selection; and performing selection upon the plurality of equalization settings of the receiver according to the plurality of parameters of the programmable filter pattern register file and a signal sequence received by the receiver.

According to a second aspect of the invention, an equalizer control apparatus is disclosed. The equalizer control apparatus is configured in a receiver, which possesses a plurality of equalization settings for selection, and the equalizer control apparatus comprises a programmable filter pattern register file and a control unit. The programmable filter pattern register file is arranged to store a plurality of parameters. The control unit is arranged to perform selection upon the plurality of equalization settings of the receiver according to the plurality of parameters of the programmable filter pattern register file and a signal sequence received by the receiver.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an equalizer control apparatus according to an exemplary embodiment of the present invention.

FIG. 2 is a flowchart illustrating an equalizer control method according to an exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

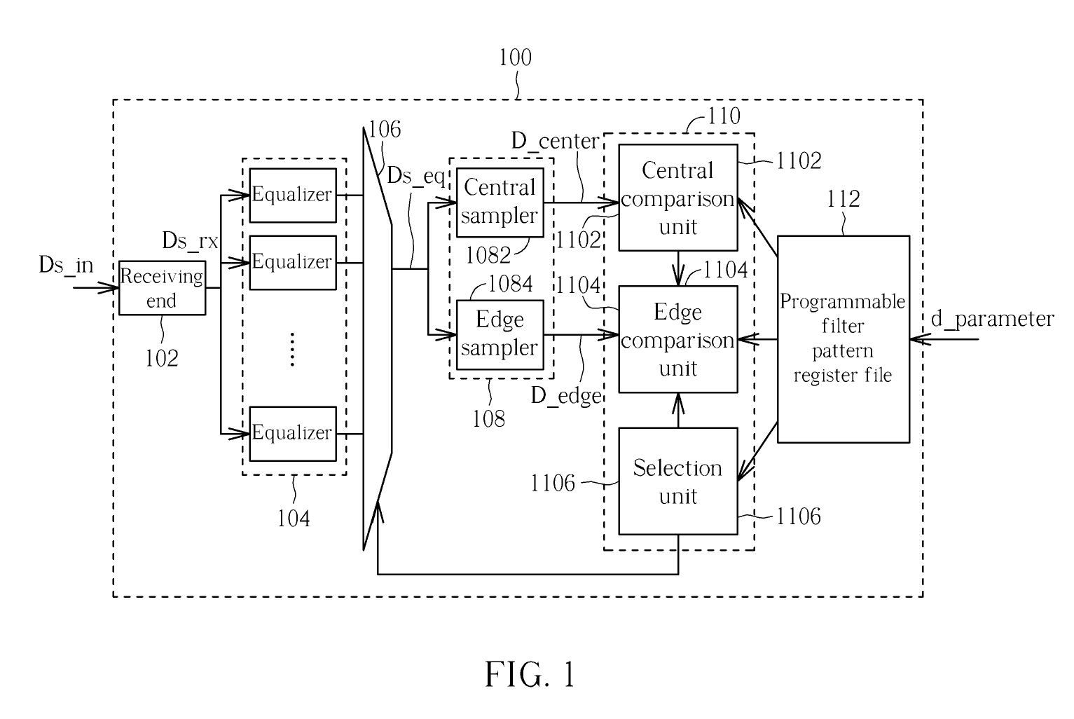

FIG. 1 is a diagram illustrating an equalizer control apparatus according to an exemplary embodiment of the present invention. In FIG. 1, a Serializer/Deserializer (SerDes) receiver 100 is applied to a high speed serial link (HSSL), wherein the SerDes receiver 100 includes a receiving end 102, an equalizer 104, a multiplexer 106, a sampler 108, an equalizer control apparatus 110 and a programmable filter pattern register file 112. A user can manually configure a plurality of parameters associated with the equalizer control according to a particular standard to which the receiver 100 targets complies. For example, when a user intends to apply the receiver 100 to the Peripheral Component Interconnect express (PCIe) 3.0, the PCIe standard 3.0 should be referred to. The plurality of parameters may include at least one filter pattern, at least one filter edge pattern corresponding to the at least one filter pattern, and at least one filter adjustment value corresponding to the at least one filter edge pattern. The plurality of parameters maybe written to a programmable filter pattern register file 112 of the receiver 100. In the invention, a serial signal d_parameter may be utilized to input the plurality of parameters; however, this is not a limitation of the invention. In an example, a parallel bus may also be used.

The filter pattern, the filter edge pattern and the filter adjustment value of the programmable filter pattern register file 112 of the receiver 100 may be defined, as shown in Table 1.

TABLE 1

| | | | Adjustment | Adjustment |
|---|---|---|---|---|
| Type | Pattern | Edge pattern | (up) | (down) |
| 0 | 5′b1_0000 | 5′b0_XXXX | 1 | 0 |
| | | 5′b 1_XXXX | 0 | 1 |
| 1 | 5′b0_1000 | 5′b 0_XXXX | 1 | 0 |
| | | 5′b 1_XXXX | 0 | 1 |
| 2 | 5′b1_0111 | 5′b 0_XXXX | 0 | 1 |
| | | 5′b 1_XXXX | 1 | 0 |
| 3 | 5′b0_1111 | 5′b 0_XXXX | 0 | 1 |
| | | 5′b 1_XXXX | 1 | 0 |

To summarize the above, when types 0-3 are detected in received signals (when the received signals include 5 bits complying with the patterns 5′b1_{—}0000, 5′b1_{—}1000, 5′b1_{—}01111, 5′b1_{—}1111), the edge type corresponding to the 5 bits maybe checked. This may comprise checking whether the sampled value of the first half clock cycle or the second half clock cycle is 5′b0_XXXX or 5′b1_XXXX, and then determining how to adjust the equalizer (e.g. switching the equalizer 104 to the previous or next configuration) according to the edge pattern.

When the receiver 100 operates, the receiving end 102 may be operable to perform a preliminary process upon a high frequency serial data signal Ds_in received from a transmission line (e.g. a cable), and to output a signal Ds_rx. The preliminary process of the receiving end 102 may include gain adjustment, high frequency noise suppression and/or timing recovery. The signal Ds_rx may be subsequently fed to the equalizer 104, wherein a plurality of filters is included therein for supporting different frequency responses. The filters may have a different respective gain for a specific frequency range in order to achieve different equalizer configuration. Further, the filters may be arranged by gain size for design convenience. The equalizer control apparatus 110 maybe operable to control the multiplexer 106 to conduct one of the filters for producing a signal Ds_eq. The details of how the equalizer control apparatus 110 controls the multiplexer 106 are described later. The signal Ds_eq may be sampled by, respectively, a central sampler 1082 and an edge sampler 1084 of the sampler 108. A sampling clock of the central sampler 1082 may be the inverse of a sampling clock of the edge sampler 1084 so that, for a clock having a 50% duty cycle, if the clock is obtained by a timing recovery process and the rising edge of the clock is aligned to the center of the signal Ds_eq, then it is suitable to directly use the clock for sampling the signal Ds_eq as an output (D_center) of the central sampler 1082, and use an inverse of the clock for sampling the signal Ds_eq as an output (D_edge) of the edge sampler 1084. Note that the invention is not limited to that shown in FIG. 1, and only modules pertinent to the invention are illustrated. The signals S_center and D_edge may both be parallel datapaths.

A central comparison unit 1102 of the equalizer control apparatus 110 may be operable to check the signal D_center in real time, in order to detect a data part with a central filter pattern, which complies with the filter pattern of the programmable filter pattern register file 112. An edge data part of the signal D_edge corresponding to the data part may be obtained. For example, when one of the filter patterns, e.g. 4′b0100, appears in the signal D_center, the central comparison unit 1102 maybe operable to notice an edge comparison unit 1104 of the equalizer control apparatus 110 in order to store the value of the signal D_edge corresponding to the signal D_center having signal pattern 4′b0100. The value sampled at the left or right edge of the signal D_center having signal pattern 4′b0100 maybe stored. A selection unit 1106 of the equalizer control apparatus 110 may be operable to perform selection upon a plurality of equalization settings in accordance with the corresponding edge data part provided by the edge comparison unit 1104 and the filter adjustment value corresponding to the edge data part (as mentioned above, the filter adjustment value is also stored in the programmable filter pattern register file 112). If the filters shown in FIG. 1 are arranged by gain size, the multiplexer 106 may be controlled to disconnect the current filter and to connect the previous or the next filter for producing the signal Ds_eq. In an alternative design, the multiplexer 106 may be operable to accumulate a predefined number of selection results, and determine the adjustment to the equalizer 104 based on the accumulated value.

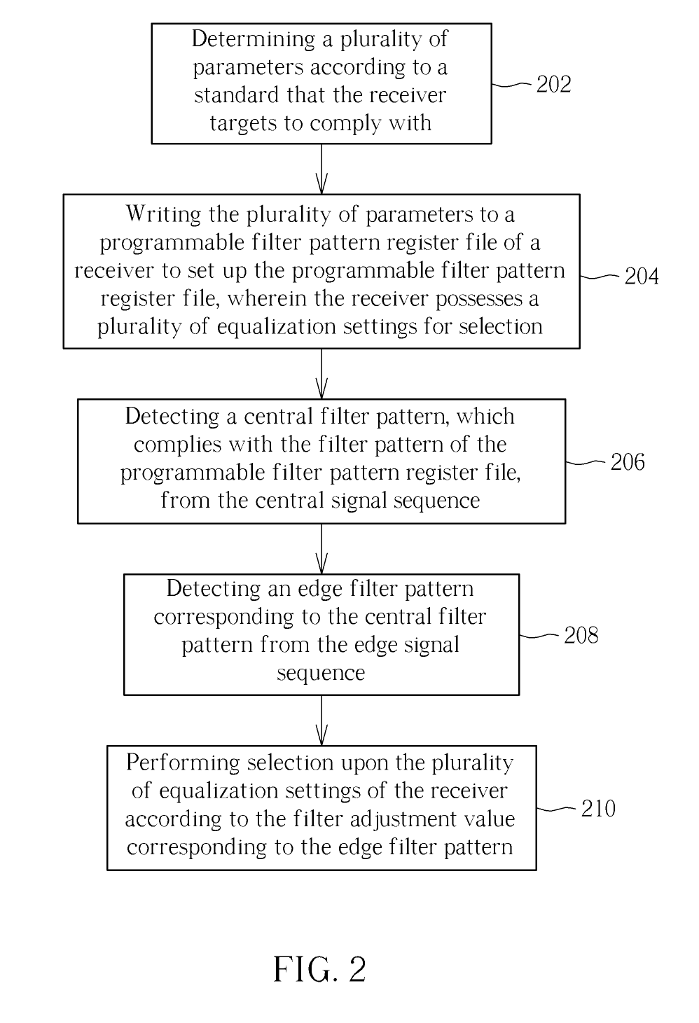

FIG. 2 is a flowchart illustrating an equalizer control method according to an exemplary embodiment of the present invention. The equalizer control method may be applied to the SerDes receiver 100 mentioned above. Provided that substantially the same result is achieved, the steps of the flowchart shown in FIG. 2 need not be in the exact order shown and need not be contiguous; that is, other steps can be intermediate. Some steps in FIG. 2 may be omitted according to various embodiments or requirements. The equalizer control method is briefly summarized as follows.

Step 202: Determine a plurality of parameters according to a standard to which the receiver targets complies;

Step 204: Write the plurality of parameters to a programmable filter pattern register file of a receiver in order to set up the programmable filter pattern register file, wherein the receiver possesses a plurality of equalization settings for selection;

Step 206: Detect a central filter pattern, which complies with the filter pattern of the programmable filter pattern register file, from the central signal sequence;

Step 208: Detect an edge filter pattern corresponding to the central filter pattern from the edge signal sequence; and

Step 210: Perform selection upon the plurality of equalization settings of the receiver according to the filter adjustment value corresponding to the edge filter pattern.

Those skilled in the art will readily understand the steps of the equalizer control method shown in FIG. 2 after reading the above paragraphs regarding FIG. 1; further description is therefore omitted here for brevity.

In summary, the invention provides flexibility to a SerDes receiver, which allows designers to configure a receiver to a specific standard afterwards.

In particular, it is envisaged that the aforementioned inventive concept can be applied by a semiconductor manufacturer to any integrated circuit. It is further envisaged that a semiconductor manufacturer may employ the inventive concept in the design of a stand-alone device, or application-specific integrated circuit (ASIC) and/or any other sub-system element.

Aspects of the invention may be implemented in any suitable form including hardware, software, firmware or any combination of these. The invention may be implemented, at least partly, as computer software running on one or more data processors and/or digital signal processors or configurable module components such as FPGA devices. Thus, the elements and components of an embodiment of the invention may be physically, functionally and logically implemented in any suitable way. The functionality may be implemented in a single unit, in a plurality of units or as part of other functional units.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor or controller. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Thus, an improved equalizer control method and an associated apparatus have been described, wherein the aforementioned disadvantages with prior art arrangements have been substantially alleviated.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An equalizer control method, comprising:
writing a plurality of parameters to a programmable filter pattern register file of a receiver to set up the programmable filter pattern register file, wherein the receiver possesses a plurality of equalization settings for selection; and
performing selection upon the plurality of equalization settings of the receiver according to the plurality of parameters of the programmable filter pattern register file and a signal sequence received by the receiver.

2. The equalizer control method of claim 1, wherein the receiver is applied to a high speed serial link (HSSL).

3. The equalizer control method of claim 1, wherein the plurality of parameters comprises at least one filter pattern, at least one filter edge pattern corresponding to the at least one filter pattern, and at least one filter adjustment value corresponding to the at least one filter edge pattern.

4. The equalizer control method of claim 3, wherein the signal sequence comprises a central signal sequence and an edge signal sequence, and the step of performing selection upon the plurality of equalization settings of the receiver according to the plurality of parameters of the programmable filter pattern register file and the signal sequence received by the receiver comprises:
detecting a central filter pattern, which complies with the filter pattern of the programmable filter pattern register file, from the central signal sequence;
detecting an edge filter pattern corresponding to the central filter pattern from the edge signal sequence; and
performing selection upon the plurality of equalization settings of the receiver according to the filter adjustment value corresponding to the edge filter pattern.

5. The equalizer control method of claim 1, further comprising:
determining the plurality of parameters according to a standard to which the receiver targets complies.

6. The equalizer control method of claim 1, wherein the plurality of parameters is written to the programmable filter pattern register file of the receiver in serial.

7. The equalizer control method of claim 1, wherein for a specific frequency rage, each equalization setting possesses a gain different from the others.

8. An equalizer control apparatus, wherein the equalizer control apparatus is configured in a receiver, the receiver possesses a plurality of equalization settings for selection, and the equalizer control apparatus comprises:
a programmable filter pattern register file, arranged to store a plurality of parameters; and
a control unit, arranged to perform selection upon the plurality of equalization settings of the receiver according to the plurality of parameters of the programmable filter pattern register file and a signal sequence received by the receiver.

9. The equalizer control apparatus of claim 8, wherein the receiver is applied to a high speed serial link (HSSL).

10. The equalizer control apparatus of claim 8, wherein the plurality of parameters comprises at least one filter pattern, at least one filter edge pattern corresponding to the at least one filter pattern, and at least one filter adjustment value corresponding to the at least one filter edge pattern.

11. The equalizer control apparatus of claim 10, wherein the signal sequence comprises a central signal sequence and an edge signal sequence, and the control unit comprises:
a central comparison unit, arranged to detect a central filter pattern, which complies with the filter pattern of the programmable filter pattern register file, from the central signal sequence;
an edge comparison unit, arranged to detect an edge filter pattern corresponding to the central filter pattern from the edge signal sequence; and
a selection unit, arranged to perform selection upon the plurality of equalization settings of the receiver according to the filter adjustment value corresponding to the edge filter pattern.

12. The equalizer control apparatus of claim 8, wherein the plurality of parameters is determined according to a standard to which the receiver targets complies.

13. The equalizer control apparatus of claim 8, wherein the plurality of parameters is written to the programmable filter pattern register file of the receiver in series.

14. The equalizer control apparatus of claim 8, wherein for a specific frequency rage, each equalization setting possesses a gain different from the others.
